(19) United States
(12) Patent Application Publication
(10) Pub. No.: US 2013/0180375 A1
(43) Pub. Date: Jul. 18, 2013

(54) RECIPROCATING SAW BLADE

(71) Applicants: Stephen B. Rearick, Canton, OH (US); Edward M. Galosi, Hudson, OH (US)

(72) Inventors: Stephen B. Rearick, Canton, OH (US); Edward M. Galosi, Hudson, OH (US)

(73) Assignee: THE M. K. MORSE COMPANY, Canton, OH (US)

(21) Appl. No.: 13/352,707

(22) Filed: Jan. 18, 2012

(51) Int. Cl. B23D 61/12

(52) U.S. Cl. 83/849; 83/835

(57) ABSTRACT

A reciprocating saw blade includes a body, and the body includes a connecting portion for connecting the blade to the saw, and a cutting edge. The cutting edge includes a plurality of teeth organized in an overall tooth set pattern. The overall tooth set pattern approximately corresponds to the stroke length of the reciprocating saw. By the overall tooth set pattern corresponding to the stroke length of the reciprocating saw, the cut time is decreased, the life of the blade is increased, the vibration is minimized and/or a smoother finishing cut is enabled.

### BACKGROUND OF THE INVENTION

1. Field of the Invention

The present invention relates to a cutting blade with a cutting edge, and in particular, to a reciprocating saw blade used to cut wood, pipe, metal and other materials. More specifically, the invention relates to a reciprocating saw blade in which the length of the overall tooth set pattern of the cutting edge corresponding to the stroke length of the reciprocating saw in which the blade is used, thereby increasing saw blade durability, decreasing cut time, providing better contact with the material, and decreasing vibration.

2. Background Art

A reciprocating saw and the reciprocating saw blade used with the saw are employed to cut various materials including metallic and wooden objects. In addition, a reciprocating saw is a useful tool in demolition-type work to cut different types of pipes and other worksite materials. The reciprocating saw utilizes a motor to move the reciprocating saw blade a predetermined stroke length back and forth through the material being cut. The reciprocating saw blade generally extends transversely, or perpendicularly, through the material being cut.

There are a number of characteristics for a reciprocating saw blade that saw blade manufacturers attempt to achieve, namely, decreased cut time, durability or longer blade life, cleaner cuts of the material, and decreased vibration for the user. The cut time is the amount of time required to cut through the specific material. The durability, or blade life, is the amount of time that a blade is utilized without being replaced or sharpened. A clean cut is the smoothness of the area where the blade cuts through the material. The vibration a user feels during operation of the saw is from the interaction between the blade and the material that is being cut.

The structure of the blade may be manipulated to affect the characteristics of the blade to achieve the aforementioned characteristics. One such structural adjustment is to increase the number of teeth within each inch of length of the saw blade.

The number of teeth per inch (“TPI”) may vary according to the work for which the blade is adapted and may vary from 5 to 21 teeth per inch. For use in general carpentry, about 5 to 8 teeth per inch is appropriate. For more intricate work, as many as 21 teeth per inch would be appropriate. Typically, the more teeth a saw blade has, the smoother the cut, but the cut time may be increased. The saw blade manufacturers must strike a balance among a smoother cut of the material, the amount of time needed to cut the material, the vibration from the saw, and the durability of the saw blade.

In order to strike such a balance, saw blade manufacturers have manipulated the orientation of the teeth in various sets or patterns. One such tooth set pattern is the raker set. The raker set pattern is at least a three-tooth sequence in which the first tooth is neutral or in the plane of the body of the saw blade, with a second tooth offset to the right of the blade, and a third tooth offset to the left of the blade, with a repeating pattern or some combination thereof. One advantage of the raker set pattern is that it has been found to lengthen the usable saw blade life.

Another tooth set pattern is the wavy set. The wavy set pattern is a repeating tooth set pattern in which a group of teeth gradually transitions to an offset to the right of the saw blade and then back to center, and another group of teeth gradually transitions to an offset to the left of the saw blade and then back to center, thus giving the appearance of a wave when the saw blade is viewed from above. One advantage of the wavy set pattern is that it decreases cut time compared to a raker set pattern, but does not have as long of a usable life. Another advantage of the wavy set pattern is that it often engages the material better than a raker set pattern and causes less vibration while cutting the material and, in turn, reduces operator fatigue.

Another tooth set pattern is the broach set. The broach set pattern may include various rake face angles and gullet depths to reduce vibration, and in turn, reduce operator fatigue, thus improving safety. The broach set pattern was designed to reduce pinching thereby preventing the saw blade from binding in the cut based on the structure of the blade. More specifically, the offset distance increases along the length of the cutting edge in the cutting direction to minimize pinching. In this manner, safety for the user is improved as a result of the user not having to release a pinched saw blade from the material. It is important to note that the broach set pattern is not common among the different tooth set patterns.

The prior art reciprocating saw blades were limited to utilizing a specific, individual tooth set pattern in different concentrations of TPI in attempts to achieve faster cut times, more durable saw blades, cleaner cuts, and/or decreased vibrations. Despite achieving some success with faster cut times, more durable saw blades, cleaner cuts, and/or decreased vibrations, improvement over the prior art reciprocating saw blades is desirable.

As a result, there is a need in the art for a reciprocating saw blade that overcomes the disadvantages of the prior art reciprocating saw blades described above. The reciprocating saw blade of the present invention satisfies this need, as will be described below.

### SUMMARY OF THE INVENTION

An objective of the present invention is to provide a reciprocating saw blade that decreases the cut time of the material being cut.

Another objective of the present invention is to provide a reciprocating saw blade that maintains and/or increases the durability of the reciprocating saw blade, thus increasing the useful life of the saw blade.

Yet another objective of the present invention is to provide a reciprocating saw blade that reduces vibration, and in turn, reduces operator fatigue while the reciprocating saw blade is cutting through the material.

A further objective of the present invention is to provide a reciprocating saw blade that enables cleaner finishing cuts of the material, and in turn, reduces burrs and thus improves safety.

These objectives and advantages are obtained by the reciprocating saw blade of the present invention. In an exemplary embodiment of the invention, a reciprocating saw blade for a reciprocating saw includes a body, and the body includes a connecting portion for connecting the saw blade to the saw and a cutting edge. The cutting edge includes a plurality of teeth and the plurality of teeth that is organized in an overall tooth set pattern. The overall tooth set pattern corresponds to a stroke length of the reciprocating saw.

### BRIEF DESCRIPTION OF THE SEVERAL VIEWS OF THE DRAWINGS

FIG. 1 is a perspective view of a first exemplary embodiment reciprocating saw blade of the invention showing a cutting edge that corresponds to the stroke length of the saw;

FIG. 2 is a side elevational view of a second exemplary embodiment of the reciprocating saw blade of the invention;

FIG. 3 is a top plan view of the reciprocating saw blade shown in FIG. 2;

FIG. 4 is an enlarged view of an individual cutting tooth as shown in FIG. 2;

FIG. 5 is a side elevational view of a third exemplary embodiment of the reciprocating saw blade of the invention;

FIG. 6 is a top plan view of the reciprocating saw blade shown in FIG. 5;

FIG. 7 is an enlarged view of an individual cutting tooth as shown in FIG. 5;

FIG. 8 is a top plan view of a fourth exemplary embodiment of the reciprocating saw blade of the invention showing an alternative tooth set pattern;

FIG. 9 is a top plan view of a fifth exemplary embodiment of the reciprocating saw blade of the invention showing another alternative tooth set pattern; and

FIG. 10 is a top plan view of a sixth exemplary embodiment of the reciprocating saw blade of the invention showing another alternative tooth set pattern.

### DETAILED DESCRIPTION OF THE INVENTION

The present invention includes a reciprocating saw blade with unique construction and improved performance over reciprocating saw blades of the prior art. More specifically, the reciprocating saw blade of the present invention achieves faster cut times while maintaining or increasing the life of the saw blade. Further, the saw blade enables cleaner cuts and decreased vibrations for the user. The reciprocating saw blade of the invention provides these advantages by arranging a tooth set pattern that corresponds to the stroke length of the reciprocating saw in addition to the prior art approach of varying the TPI. This structure enables the reciprocating saw blade to provide faster cut times, maintain or increase the blade life, decrease vibration and enable cleaner cuts when compared to prior art reciprocating saw blades. In a non-limiting example, the overall length of the tooth set pattern corresponds to a range of approximately 80 to 120 percent of the stroke length of the reciprocating saw, including stroke lengths of one and one-eighth of an inch (1.125 in.) and one and one-fourth of an inch (1.250 in.). In addition, the present invention of the reciprocating saw blade enables different individual tooth set patterns to be used in combination to approximately correspond to the stroke length of the saw.

It is to be understood that the present invention applies to any type of saw blade with reciprocating motion, including reciprocating saw blades, jigsaw saw blades, saber saw blades, hacksaw blades and scroll saw blades, all of which shall be referred to herein for the purpose of convenience as a reciprocating saw blade.

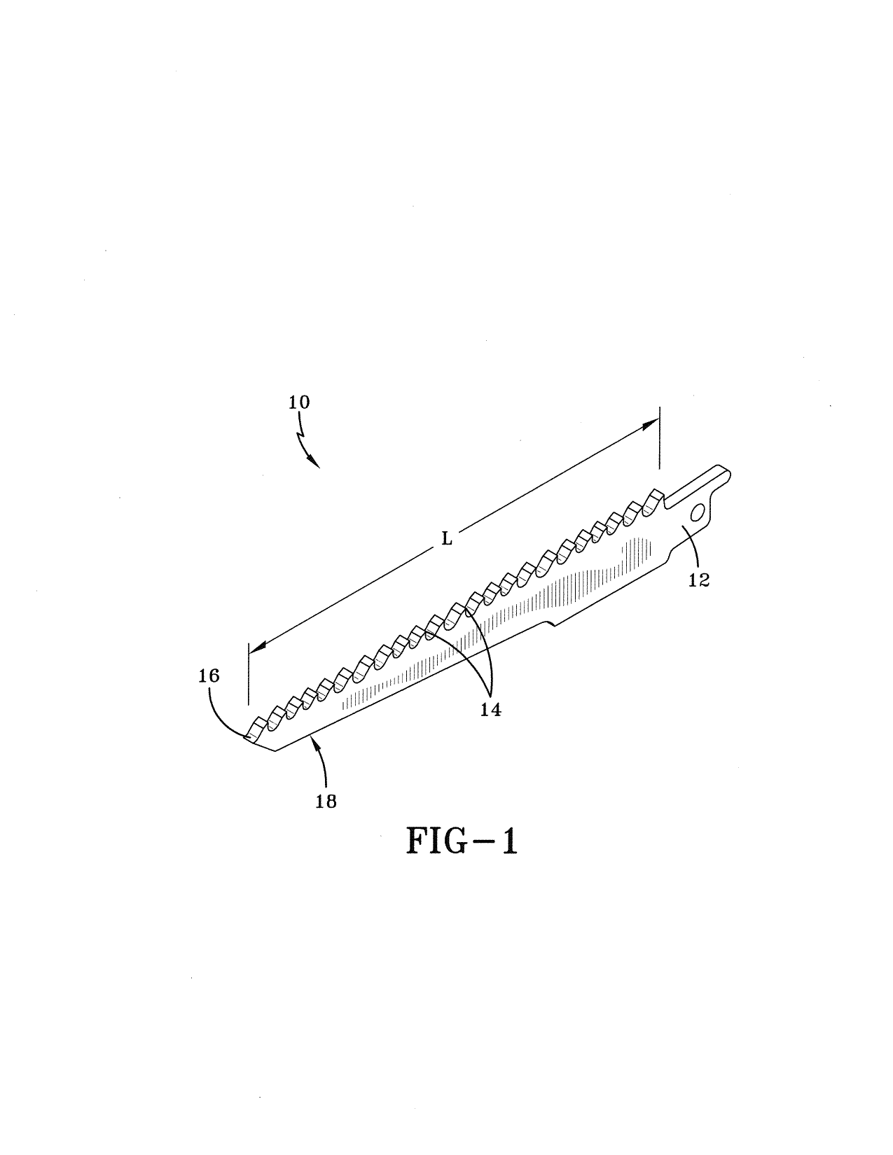

A first exemplary embodiment reciprocating saw blade of the present invention is shown generally at 10 in FIG. 1. Saw blade 10 includes a body 18, and a connecting portion 12 and a cutting edge 16 formed on the body. Connecting portion 12 enables saw blade 10 to be inserted and securely connected to a corresponding saw (not shown) as known in the art. Cutting edge 16 includes a plurality of teeth 14 that may be organized in a specific tooth set pattern, as will be described below. Cutting edge 16 is of a length L, along which teeth 14 extend, as will be described in detail below.

The stroke length of a reciprocating saw blade is the distance the reciprocating saw blade extends away from, or back towards, the reciprocating saw in a back-and-forth movement. The stroke length is dependent upon the saw itself. Typically, the longer the stroke length of the reciprocating saw, the more efficient the saw will be at cutting the material because the longer stroke length allows more teeth to engage the material.

Two of the most common stroke lengths for reciprocating saws include 1.125 in. and 1.250 in. Thus, a reciprocating saw with the stroke length of 1.125 in. extends the saw blade outwardly 1.125 in. and then back inwardly 1.125 in. The 1.125 in. stroke length of a reciprocating saw may also be written as 28.575 millimeters (mm.). Further, the 1.250 in. stroke length of a reciprocating saw may be written as 31.75 mm. Similarly, a reciprocating saw with the stroke length of 1.250 in. extends the saw blade outwardly 1.250 in. and then back towards the reciprocating saw 1.250 in.

In first exemplary embodiment reciprocating saw blade 10, teeth 14 extend a length L of cutting edge 16. Teeth 14 may be organized in different orientations and/or positions to form different tooth set patterns. These tooth set patterns are organized into a tooth set pattern length that approximately corresponds to the stroke length of the reciprocating saw. The individual tooth set patterns, as will be discussed in more detail below, combine to form an overall tooth set pattern length. The overall tooth set pattern length corresponds to the reciprocating saw stroke length. In a non-limiting example, the overall tooth set pattern length approximately corresponds to a stroke length of 1.125 in. for a 1.125 in. reciprocating saw.

Further, the overall tooth set pattern length approximately corresponds to a range of about 80 to 120 percent of the stroke length. In a non-limiting example, the overall tooth set pattern length corresponding to a range of about 80 to 120 percent for a 1.250 in. reciprocating saw corresponds to a range of about 1.000 in. to about 1.500 in. for the stroke length of the reciprocating saw.

In another non-limiting example, a 1.125 in. reciprocating saw would correspond to an overall tooth set pattern length in the range of about 0.900 in. to about 1.350 in. for about 80 to 120 percent of the stroke length.

In this manner, the overall tooth set pattern length approximately corresponds to the stroke length of the reciprocating saw, in addition to adjusting the concentration of teeth per inch along the cutting edge, namely TPI.

As a result of enabling the overall tooth set pattern length to approximately correspond to the stroke length of the reciprocating saw, faster cut times are achieved with reciprocating saw blade 10, which in turn enables more material to be cut in a predetermined amount of time. In addition, the life of the saw is maintained and/or increased when the overall tooth set pattern length approximately corresponds to the stroke length when compared to saw blades solely utilizing variable TPI. This provides cost-savings for the user because saw blades may be used longer without the need to purchase new saw blades. Further, the vibration an operator feels during operation of the saw is reduced, thus operator fatigue is diminished, due to the overall tooth set pattern length corresponding to the stroke length of the reciprocating saw. This is a result of the individual teeth of the overall set pattern length in increased contact with the material being cut when compared to saw blades solely utilizing variable TPI. Moreover, the finished cut is smoother, thus minimizing burrs and improving safety, when the overall tooth set pattern length approximately corresponds to the stroke length because of the increased contact with the material being cut.

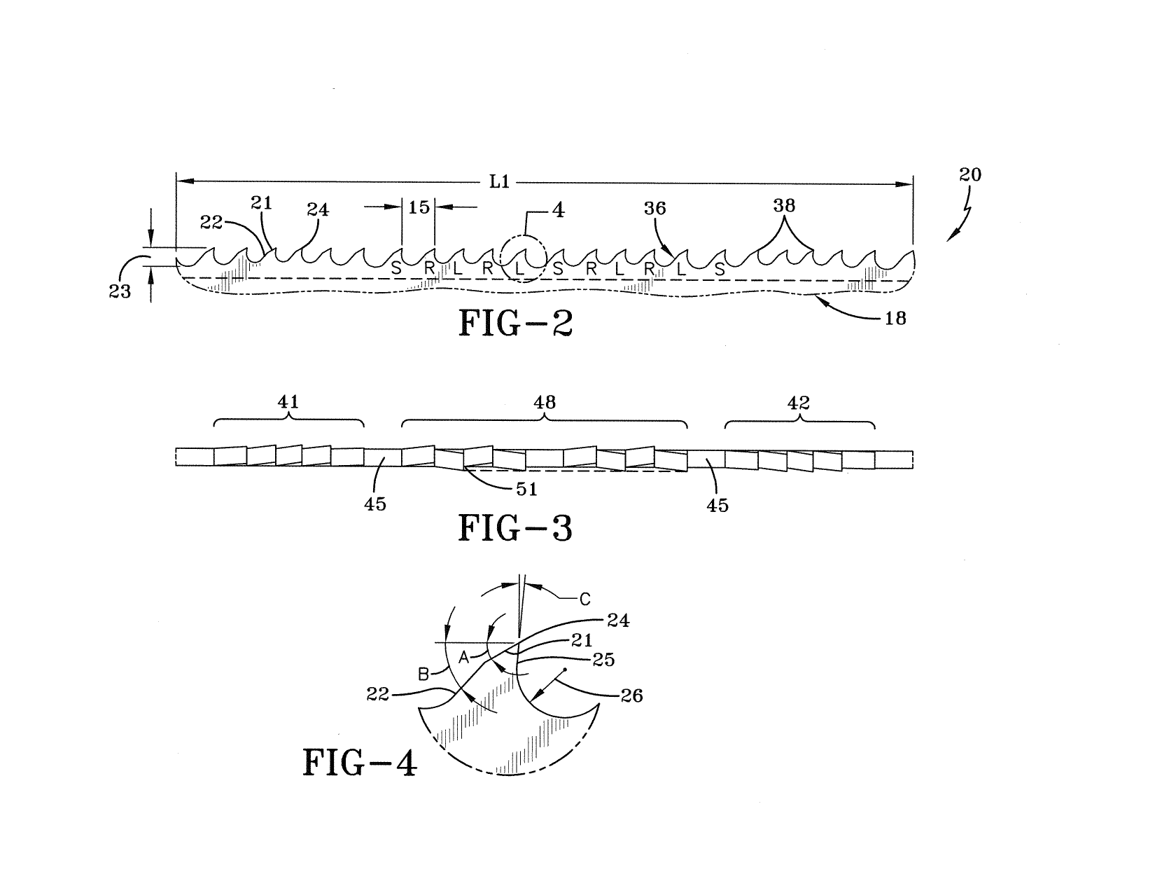

FIGS. 2-4 show a second exemplary embodiment of reciprocating saw blade 20. Saw blade 20 includes an overall tooth set pattern length that approximately corresponds to the stroke length of the reciprocating saw (not shown). More particularly, saw blade 20 includes an overall tooth set pattern length that is approximately 80 to about 120 percent of the stroke length of the reciprocating saw. As shown, saw blade 20 includes an overall tooth set pattern of a length L1 that is about 1.422 in. for a reciprocating saw stroke length of about 1.250 in.

A combined tooth set pattern may correspond to the overall tooth set pattern length. A combined tooth set pattern is when at least two different individual tooth set patterns are combined on a cutting edge 36 of saw blade 20. An individual tooth set pattern includes a wavy set, a raker set, a broach set or an arc set. When at least two different individual tooth set patterns are combined onto cutting edge 36, the advantages of the individual tooth set patterns are obtained for the combined tooth set pattern.

One such combined tooth set pattern is a wavy set and a raker set. The combined tooth set pattern in FIGS. 2-4 includes a wavy set right 41, a wavy set left 42 and a raker set 48 within the overall tooth set pattern that corresponds to the stroke length of the saw (not shown).

Wavy set right 41 is separated from raker set 48 by a straight tooth transition 45. Similarly, wavy set left 42 is separated from raker set 48 by another straight tooth transition 45. Raker set 48 is offset from body 18 by an offset distance 51. Offset distance 51 ranges from about 0.003 in. to about 0.013 in. Preferably, offset distance 51 is about 0.008 in.

Similarly, wavy set right 41 and wavy set left 42 are offset from body 18 by offset distance 51. Offset distance 51 ranges from approximately 0.003 in. to about 0.013 in. Preferably, offset distance 51 is about 0.008 in.

Cutting edge 36 includes a plurality of teeth 38 with each tooth having a primary clearance surface 21, a secondary clearance surface 22, a tip height 23, a tip 24, and a rake face 25. The distance between individual tips 24 is referred to as a tip pitch 15. Tip pitch 15 ranges are based on the specific tooth set pattern.

By way of example, tip pitch 15 for wavy set right 41 and wavy set left 42 ranges from approximately 0.048 in. to about 0.072 in. Tip pitch 15 for raker set 48 ranges from approximately 0.054 in. to about 0.082 in. The total length of cutting edge 36 ranges from approximately 1.417 in. to about 1.427 in. but it is preferably about 1.422 in.

Tip height 23 is the distance plurality of teeth 38 elevates above the body 18 of the saw blade 20. Tip height 23 ranges in height from approximately 0.023 in. to about 0.043 in.

The primary clearance surface 21 has a primary acute relief angle A from with the longitudinal axis of tip 24 and is located opposite of rake face 25. The primary acute relief angle A ranges from approximately 29 degrees to about 31 degrees. Preferably, the primary acute relief angle A is approximately 30 degrees.

Secondary clearance surface 22 for wavy set right 41, wavy set left 42 and raker set 48 has a secondary acute relief angle B with a longitudinal axis of the reciprocating saw blade 10 and is located adjacent to primary clearance surface 21. Secondary acute relief angle B ranges from approximately 47 degrees to about 49 degrees. Preferably, secondary acute relief angle B is approximately 48 degrees.

On the opposing side of primary clearance surface 21 and secondary clearance surface 22 is rake face 25. Rake face 25 protrudes from a perpendicular axis to the longitudinal axis of the reciprocating saw blade 20 at an angle of the rake face protrusion C. Angle of the rake face protrusion C ranges from approximately 4 degrees to about 6 degrees. Preferably, angle of the rank face protrusion C is approximately 5 degrees.

Rake face 25 is defined by a radius 26 and is the area into which the chip curls when a cut is made. The radius of rake face 25 for wavy set right 41 and wavy set left 42 ranges from approximately 0.012 in. to about 0.025 in. Radius of the rake face 25 for raker set 48 ranges from approximately 0.012 in. to about 0.030 in.

As a result of enabling the overall tooth set pattern length to include combined tooth set patterns and to approximately correspond to the stroke length of the reciprocating saw, faster cut times are achieved with reciprocating saw blade 20, enabling more material to be cut in a predetermined amount of time. Further, the life of the saw is maintained and/or increased when the overall tooth set pattern length approximately corresponds to the stroke length and combined tooth set patterns are employed while also including variable TPI. This provides cost-savings for the user because saw blades may be used longer without the need to purchase new saw blades. Even further, the vibration a user feels during operation of the saw is reduced, and, in turn, operator fatigue is reduced due to the overall tooth set pattern length corresponding to the stroke length of the reciprocating saw and the combined tooth set patterns. Moreover, the finished cut is smoother, minimizing burrs, and, in turn, improving safety, when the overall tooth set pattern length approximately corresponds to the stroke length and combined tooth set patterns are used.

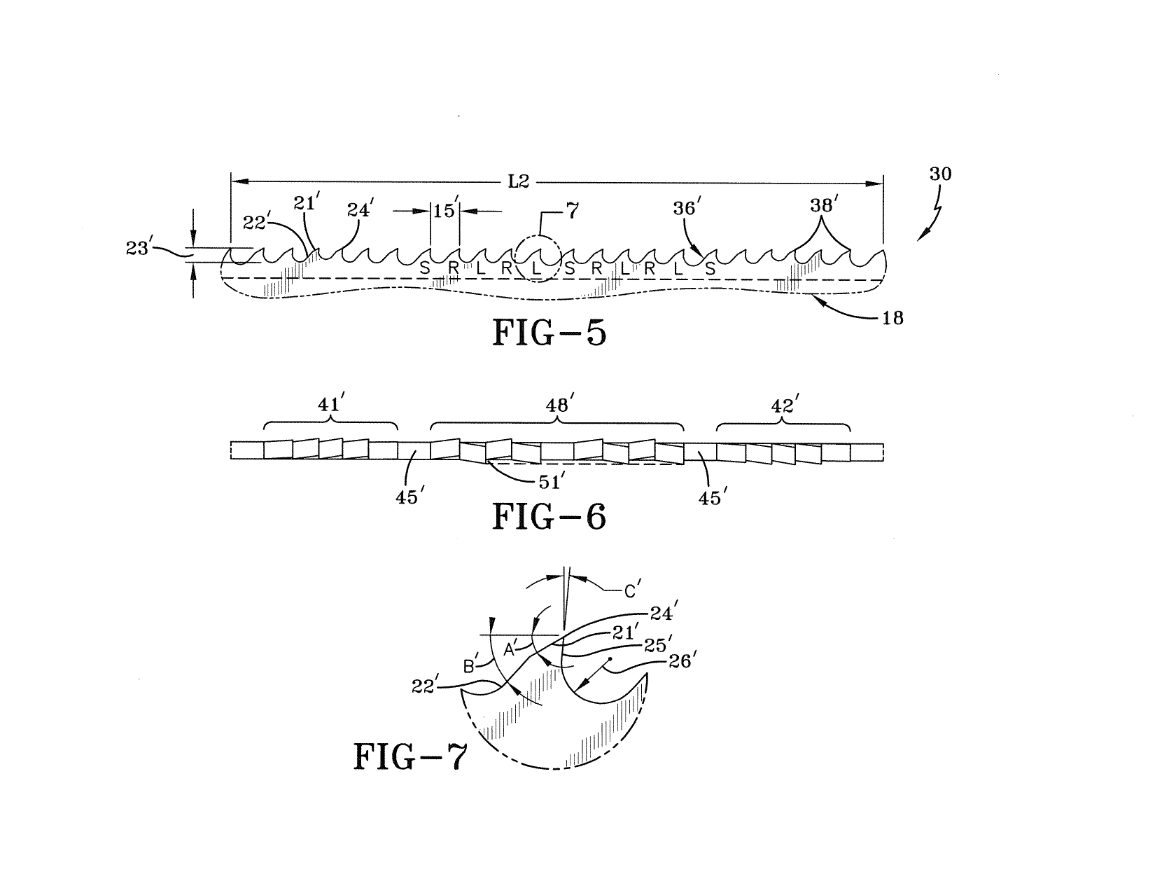

Turning to FIGS. 5-7, FIGS. 5-7 show a third exemplary embodiment of reciprocating saw blade 30. Saw blade 30 includes an overall tooth set pattern length that approximately corresponds to the stroke length of the reciprocating saw. More particularly, saw blade 30 includes an overall tooth set pattern length that is approximately 80 to about 120 percent of the stroke length of the reciprocating saw. As shown, saw blade 30 includes an overall tooth set pattern of a length L2 that is about 1.260 in. for a reciprocating saw stroke length of about 1.125 in.

FIG. 5-7 show another combined tooth set pattern approximately corresponding to the stroke length of the saw utilizing a set pattern length of a wavy set right 41′, a raker set 48′, and a wavy set left 42′.

Wavy set right 41′ is separated from raker set 48′ by a straight tooth transition 45′. Similarly, wavy set left 42′ is separated from raker set 48′ by another straight tooth transition 45′. Raker set 48′ is offset from body 18 by an offset distance 51′. The offset distance 51′ ranges from approximately 0.003 in. to about 0.013 in. Preferably, the offset distance 51′ is approximately 0.008 in.

Similarly, wavy set right 41′ and wavy set left 42′ are offset from body 18 by offset distance 51′. Offset distance 51′ ranges from approximately 0.003 in. to about 0.013 in. Preferably, offset distance 51′ is approximately 0.008 in.

By way of example, a plurality of teeth 38′ of cutting edge 36′ with each individual tooth have a primary clearance surface 21′, a secondary clearance surface 22′, a tip height 23′, a tip 24′, and a rake face 25′. The distance between individual tips 24′ is tip pitch 15′. Tip pitch 15′ ranges are based on the individual tooth set pattern. Tip pitch 15′ for wavy set right 41′ and wavy set left 42′ ranges from approximately 0.043 in. to about 0.064 in. Tip pitch 15′ for raker set 48′ ranges from approximately 0.048 in. to about 0.070 in. The total length of cutting edge 36′ ranges from approximately 1.255 in. to about 1.265 in. but is preferably about 1.260 in.

Tip height 23′ is the distance plurality of teeth 36′ elevates above the body 18 of the saw blade 30. The tip height 23′ ranges in height from approximately 0.018 in. to about 0.039 in.

Primary clearance surface 21′ has a primary acute relief angle A from the longitudinal axis of the reciprocating saw blade 30. Primary acute relief angle A′ ranges from approximately 29 degrees to about 31 degrees. Preferably, primary acute relief angle A′ is approximately 30 degrees.

Secondary clearance surface 22′ for wavy set right 41′, wavy set left 42′ and raker set 48′ has a secondary clearance relief angle B′ with a longitudinal axis of the reciprocating saw blade 10. Secondary clearance relief angle B′ ranges from approximately 47 degrees to about 49 degrees. Preferably, secondary clearance relief angle B′ is about 48 degrees.

On the opposing side of primary clearance surface 21′ and secondary clearance surface 22′ is rake face 25′. Rake face 25′ has an angle of rake face protrusion C′ which is the angle from the rake face 25′ protrudes from a perpendicular axis to the longitudinal axis of the reciprocating saw blade 30. Angle of rake face protrusion C′ ranges from approximately 4 degrees to about 6 degrees. Preferably, angle of rake face protrusion C′ is approximately 5 degrees.

Rake face 25′ is defined by radius 26′ and is the area into which the chip curls when a cut is made. Radius of the rake face 25′ for wavy set right 41′ and wavy set left 42′ ranges from approximately 0.011 in. to about 0.022 in. The radius of the rake face 25′ for raker set 48′ ranges from approximately 0.012 in. to about 0.025 in.

As a result of enabling the overall tooth set pattern length to include combined tooth set patterns and to approximately correspond to different stroke lengths for a reciprocating saw, faster cut times are achieved with reciprocating saw blade 30, enabling more material to be cut in a predetermined amount of time. In addition, the life of the saw is maintained and/or increased when the overall tooth set pattern length approximately corresponds to the stroke length and combined tooth set patterns are employed. This provides cost-savings for the user because saw blades may be used longer without the need to purchase new saw blades. Moreover, the vibration a user feels during operation of the saw is reduced, thus operator fatigue is diminished, due to the overall set pattern length corresponding to the stroke length of the reciprocating saw and the combined tooth set patterns. Further, the finished cut is smoother, minimizing burrs, and, in turn, improving safety, when the overall tooth set pattern length approximately corresponds to the stroke length and combined tooth set patterns are used.

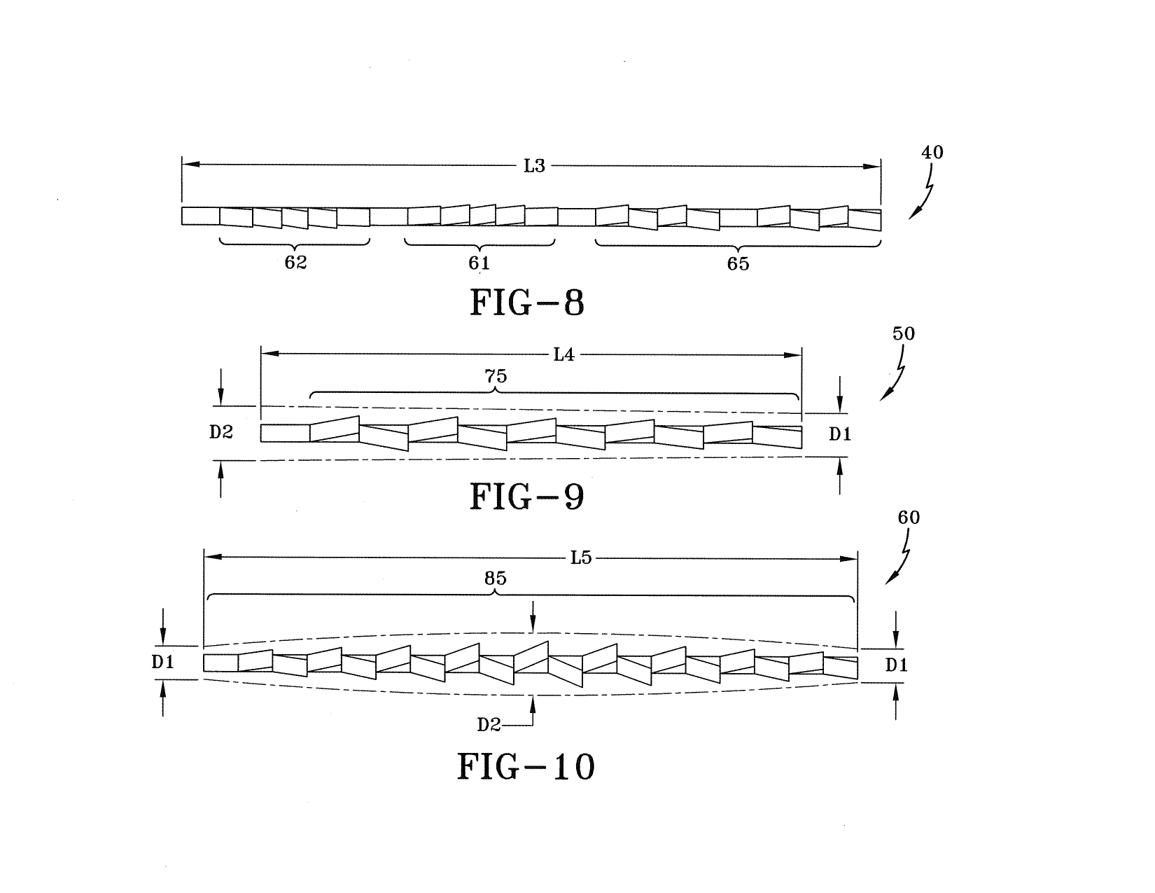

Turning to FIGS. 8-10, FIG. 8 shows a fourth exemplary embodiment of the present invention reciprocating saw blade 40 with a different arrangement of the individual tooth set patterns within the overall tooth set pattern than FIGS. 3 and 6. By way of example, a combined tooth set pattern is formed by the individual tooth set pattern that includes a wavy set left 62, a wavy set right 61, followed by a raker set 65. The overall tooth set pattern is of a length L3 that approximately corresponds to the stroke length of the reciprocating saw. By altering the order of the individual tooth set patterns and approximately corresponding the overall tooth set pattern to the stroke length of the saw, faster cut times are achieved enabling more material to be cut in a predetermined amount of time.

FIG. 9 shows a fifth exemplary embodiment of the present invention reciprocating saw blade 50 with a different type of tooth set pattern, namely, a broach set 75, which is also called a variable tooth set pattern. It is important to note that broach set 75 is only occasionally used as a tooth set pattern. Broach set 75 may have various rake face angles and gullet depths to reduce vibration, and, in turn, reduce operator fatigue, thus improving safety, and, further includes increasing the offset distance from the saw body from distance D1 to D2 in the cutting direction. The increasing offset distance minimizes the chance of pinching the saw blade with the material thus further improving safety. The overall tooth set pattern is of a length L4 that approximately corresponds to the stroke length of the reciprocating saw. Broach set 75 enables reciprocating saw blade 50 to decrease the cut time, provide a smoother cut, and decrease vibration when compared to other individual tooth set patterns because of the structure of the saw blade, namely, increasing the offset distance from the saw body from D1 to D2 in the cutting direction.

FIG. 10 shows a sixth exemplary embodiment of the present invention reciprocating saw blade 60 with a different type of individual tooth set pattern, namely, an arc set 85. Arc set 85 increases the offset distance from the saw body from D1 to D2 and back to D1 in the cutting direction within the same stroke. The overall tooth set pattern is of a length L5 that approximately corresponds to the stroke length of the reciprocating saw. Arc set 85 enables reciprocating saw blade 60 to decrease the cut time, provide a smoother cut to minimize burrs thus improving safety, and decrease vibration thus reducing user fatigue when compared to other individual tooth set patterns because of the structure of the saw blade, namely, increasing the offset distance from the saw body from D1 to D2 and back to D1 in the cutting direction within the same stroke. Further, the arc set minimizes the risk of pinching of the saw blade as a result of the larger offset distance when comparing D1 and D2.

Reciprocating saw blade 10, 20, 30, 40, 50 and 60 of the present invention overcomes the disadvantages associated with prior art reciprocating saw blades, such as those described above, which solely include varying the concentrations of TPI in attempts to achieve faster cut times, more durable saw blades, cleaner cuts, and decreased vibrations for the user. By arranging an overall tooth set pattern length to correspond to the stroke length of the saw blade, the reciprocating saw blade of the present invention overcomes the prior art disadvantages.

By arranging the overall tooth set pattern length to correspond to the stroke length of the reciprocating saw and employing combined tooth set patterns, faster cut times are achieved enabling more material to be cut in a predetermined amount of time. In addition, the life of the saw blade is maintained and/or increased when the overall tooth set pattern length approximately corresponds to the stroke length when compared to saw blades solely utilizing variable TPI, and when combined tooth set patterns are used. This provides cost-savings for the user because saw blades may be used longer without the need to purchase new saw blades. Moreover, the vibration an operator feels during operation of the saw is reduced thus minimizing user fatigue and improving safety as a result of the overall set pattern length corresponding to the stroke length of the reciprocating saw. The minimized vibration is a result of the individual teeth of the overall set pattern length being in increased contact with the material being cut when compared to saw blades solely utilizing variable TPI, and because combined tooth set patterns are employed. Further, the finished cut is smoother thus reducing the amount of burrs, and in turn, improving safety, when the overall tooth set pattern length approximately corresponds to the stroke length because of the increased contact with the material being cut, and when combined tooth set patterns are used.

It is contemplated that the exemplary embodiments of the reciprocating saw blade of the present invention may be altered for other types of cutting blades without changing the overall concept or operation of the present invention. It is further contemplated that a different order for the tooth set patterns may be employed without changing the overall concept or operation of the present invention. It is also contemplated that the arrangement for the tooth set pattern would include any combination of a wavy tooth set, raker tooth set, a broach tooth set, and an arc tooth set without changing the overall concept or operation of the present invention.

Moreover, different tip pitches for the teeth are contemplated without changing the overall concept or operation of the present invention. Tooth structures other than those shown and described herein are contemplated without changing the overall concept or operation of the present invention. In addition, stroke lengths other than those described herein are contemplated without changing the overall concept or operation of the present invention. It is also contemplated that the range of the overall tooth set pattern corresponding to the stroke length may be outside of the range of approximately 80 percent to about 120 percent of the stroke length without changing the overall concept or operation of the present invention.

It is contemplated that reciprocating saw blade may be made of any material known to those in the art that is suitable for cutting without changing the overall concept or operation of the present invention. It is further contemplated that other types of cutting blades, other than reciprocating saw blades, may utilize an overall tooth set pattern that corresponds to the stroke length of the saw blade in addition to varying the TPI without changing the overall concept or operation of the present invention. The present invention reciprocating saw blade may apply to other types of oscillating saw blades, including jigsaw blades, saber saw blades, scroll saw blades and hacksaw blades, without changing the overall concept or operation of the present invention.

Accordingly, the reciprocating saw blade of the present invention provides an efficient structure which achieves all the enumerated objectives, provides for eliminating inefficiencies encountered with prior art reciprocating saw blades and solves problems and obtains new results in the art.

In the foregoing description, certain terms have been used for brevity, clearness and understanding, but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the reciprocating saw blade of the present invention is used, the characteristics of construction, and the advantageous, new and useful results obtained; the new and useful structures, elements, arrangements, process, parts and combinations are set forth in the appended claims.

What is claimed is:

1. A reciprocating saw blade for a reciprocating saw including:
a body, said body including a connecting portion for connecting said blade to said saw, and a cutting edge;
said cutting edge including a plurality of teeth;
said plurality of teeth organized in an overall tooth set pattern; and
said overall tooth set pattern corresponding to a stroke length of said reciprocating saw.

2. The reciprocating saw blade of claim 1 wherein said overall tooth set pattern corresponds to a range from about 80 percent to about 120 percent of said stroke length.

3. The reciprocating saw blade of claim 2 wherein said overall tooth set pattern includes at least one of a wavy set, a raker set, a broach set, and an arc set.

4. The reciprocating saw blade of claim 3 wherein said overall tooth pattern includes a wavy set right, a raker set, and a wavy set left.

5. The reciprocating saw blade of claim 3 wherein said stroke length is about 1.125 inches.

6. The reciprocating saw blade of claim 3 wherein the stroke length is about 1.250 inches.

7. The reciprocating saw blade of claim 1 wherein said overall tooth set pattern includes at least one of a wavy set, a raker set, a broach set, and an arc set.

8. The reciprocating saw blade of claim 7 wherein said overall tooth set pattern includes a wavy set right, a raker set, and a wavy set left.

9. The reciprocating saw blade of claim 7 wherein said stroke length is about 1.125 inches.

10. The reciprocating saw blade of claim 7 wherein said stroke length is about 1.250 inches.
